(19) United States
(12) Patent Application Publication
(10) Pub. No.: US 2006/0214789 A1
(43) Pub. Date: Sep. 28, 2006

(54) Tamper detection with RFID tag

(76) Inventors: Joshua Posamentier, Oakland, CA (US); Jeremy Burr, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/089,916

(22) Filed: Mar. 24, 2005

(51) Int. Cl. G08B 13/08

(52) U.S. Cl. 340/545.6; 340/572.1; 340/10.1

(57) ABSTRACT

A sensor may be used to detect a previous or current change of state, and the change may be reported by a radio frequency identification (RFID) tag. In some embodiments, the change may represent a broken security seal, which in turn may affect an electrical connection that can be sensed by the RFID tag during operation of the RFID tag.

### BACKGROUND

Tamper detection devices and other event detection devices frequently depend on visual inspection of a mechanism that permanently changes its mechanical properties in response to a particular event. For example, tamper detection for a medicine bottle may be indicated with a paper seal that is attached to both the bottle and the bottle cap, such that opening the cap tears the paper. If visual inspection shows that the seal is torn, that indicates that the cap has been removed and the contents of the bottle possibly tampered with. If the seal is intact, it is assumed that the bottle has not been opened. While such indicators are inexpensive and generally reliable, detection depends on a human being visually looking at the seal. Such techniques are not efficient for inspecting large numbers of containers, or for inspecting containers that are not easily viewed, such as the contents of a shipping bay in a commercial freight vehicle.

### BRIEF DESCRIPTION OF THE DRAWINGS

The invention may be understood by referring to the following description and accompanying drawings that are used to illustrate embodiments of the invention. In the drawings:

FIG. 1 shows a block diagram of an RFID tag and security sensor, according to an embodiment of the invention.

FIG. 2 shows a diagram of a security device on the door(s) of a container, according to an embodiment of the invention.

FIG. 3 shows a diagram of a security sensor with a continuity loop, according to an embodiment of the invention.

FIG. 4 shows a container with an RFID tag and an environmental change indicator, according to an embodiment of the invention.

FIG. 5 shows a flow diagram of a method performed by an RFID tag, according to an embodiment of the invention.

FIG. 6 shows a flow diagram of a method performed by an RFID reader, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, the different embodiments described may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions stored on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), the interfaces and/or antennas that transmit and/or receive those signals; and others.

Within the context of this document, a radio frequency identification (RFID) tag comprises an RFID tag circuit to provide data storage and signal processing within the RFID tag, and an RFID antenna to receive and transmit signals to/from the RFID tag. Within the context of this document, the definition of ‘transmission’ from an RFID tag may include the modulated reflection of a wireless signal received by the associated RFID antenna.

Some embodiments of the invention include an RFID tag whose response includes the status of a security sensing element. The security sensing element may indicate the status of a security device whose characteristics are changed by the occurrence of a particular physical event, such as opening a container. In some of those embodiments, that event may change the electrical coupling between the sensing element and the RFID tag, such as by breaking the continuity of an electrical element in a manner that is essentially irreversible, or by changing a multi-bit readout between the sensing element and the RFID tag.

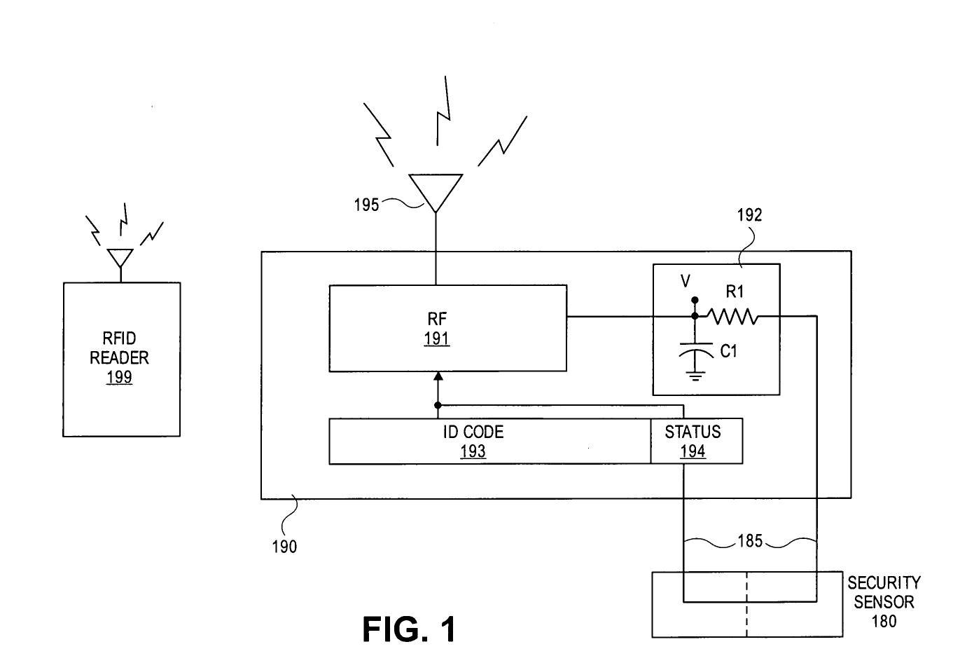

FIG. 1 shows a block diagram of an RFID tag and security sensor, according to an embodiment of the invention. In the illustrated embodiment, the RFID tag comprises RFID tag circuit 190 and RFID antenna 195. Security sensor device 180 is also shown coupled to RFID tag circuit 190 through a breakable continuity loop 185. The security sensor device 180 may be constructed such that when mounted on an openable container, the security sensor device 180 and the continuity loop 185 will both break (e.g., along the indicated dashed lines) if the container is opened.

The illustrated RFID tag circuit 190 may comprise various components, such as, for example, RF circuitry 191 to receive and transmit radio frequency signals, identification register 193 to contain a code in non-volatile circuitry that identifies the RFID tag, a status circuit 194 to indicate a status of security sensor 180, and a power circuit 192 to provide electrical power to operate the various other components 191, 193, and 194. In some embodiments, some of the electrical energy from incoming signals that are received through antenna 195 may be collected in power circuit 192 (e.g., stored in capacitor C1), until there is sufficient electrical energy to operate the other components of RFID tag circuit 190. Also, when there is sufficient stored electrical power for such operation, the voltage V may be fed through continuity loop 185 to provide a detectable voltage input to status circuit 194. In some embodiments, resistor R1 may be used to prevent a short circuit between continuity loop 185 and ground from shutting down operation of the RFID tag by draining the voltage out of capacitor C1.

Security sensor 180 may be physically mounted or otherwise attached to a container with a door, lid, or other opening device, in a manner that causes the continuity loop to break if the container is opened. In the illustrated embodiment, such a break may occur along the dashed lines, causing the continuity loop 185 to physically break in two. This may in turn prevent the voltage from power circuit 192 from reaching the input of status circuit 194. Various circuit design techniques, both currently known and yet to be developed, may be used to make sure the operational input to status circuit 194 is in one state when the continuity loop 185 is intact, and in another state when continuity loop 185 is broken. The illustrated embodiment may provide a logic high signal when continuity is present, and a logic low signal when continuity is absent, but the opposite convention may also be used. In some embodiments, when the RFID tag is not operational, the state of the input to status circuit 194 may not matter.

When the RFID tag is prompted to transmit, for example by receiving a radio frequency signal transmitted by RFID reader 199, the RFID tag may transmit the identification code in identification register 193, as well as the status indicated by status circuit 194. In some embodiments this data may be transmitted in a bit-serial fashion, by being shifted through a shift register to the RF circuit 191. In some embodiments, status circuit 194 may comprise a flip-flop, register, or other circuit element that stores the state as long as power is available to status circuit 194. In other embodiments, status circuit 194 may merely provide the signal level in a non-stored state as an input to be sensed and transmitted only when needed. In some embodiments a single bit may be used to indicate continuity status, while in other embodiments multiple bits may provide that status. The status bit(s) may be located at any feasibly point in the data transmitted by the RFID tag.

In some embodiments the RFID tag may be ‘polled’ by an RFID reader when the RFID tag is to respond. An RFID poll may take any of various forms, such as but not limited to: 1) receipt of any RF energy that will be accumulated in the power circuit 192, 2) receipt of RF energy in the proper frequency band, 3) receipt of a modulated signal that indicates this specific RFID tag is to respond, 4) etc. In response to a poll, the RFID tag may transmit the contents of identification register 193 and status circuit 194, as well as any other information (not shown) the RFID tag may be designed to transmit.

In some embodiments the RFID tag may be a ‘passive’ RFID tag, i.e., it may use the energy from incoming signals to power its own circuits, and its circuits may be non-operational in the absence of such incoming signals. In other embodiments (not shown), the RFID tag may be an ‘active’ tag, i.e., it may receive operational power from a battery or other internal power source. In either case, when the RFID tag is active, the continuity of loop 185 may be sensed at status circuit 194, and that continuity status may be transmitted along with any other pertinent information the RFID tag may be designed to transmit.

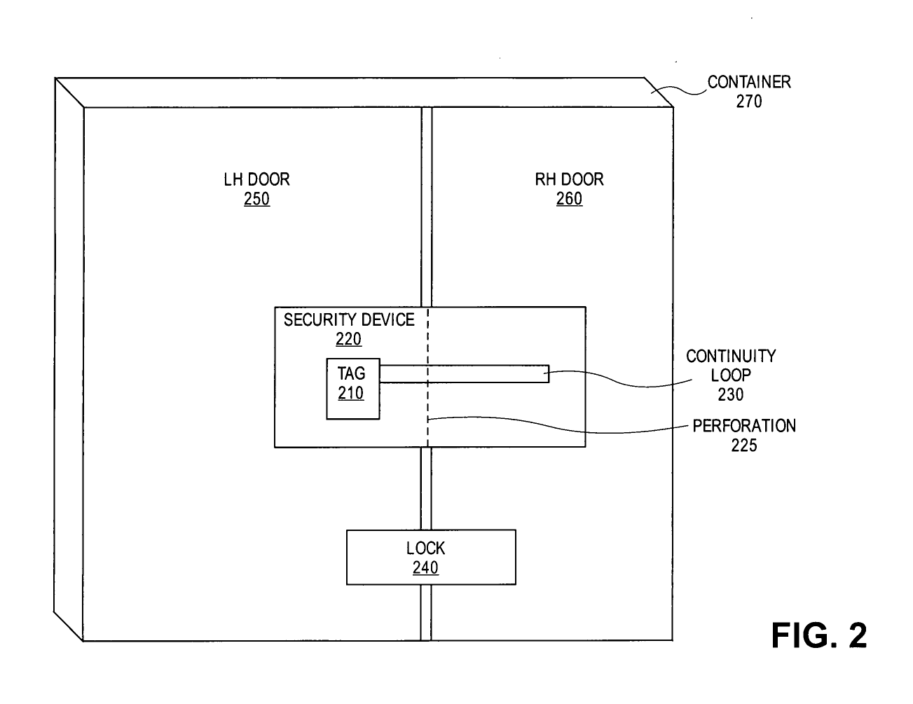

FIG. 2 shows a diagram of a security device on the door(s) of a container, according to an embodiment of the invention. In the illustrated embodiment, security device 220 may be physically attached to one or more doors 250, 260 of a container 270, in a manner that causes the security device 220 to physically break when the door(s) are opened. In some embodiments a lock 240 may also be used to enhance security by making unauthorized opening of the doors more difficult. Although a rectangular cabinet with doors is shown, the same principals may be used on any type of container with a movable part that acts to open and/or close the container. Such containers may include, but are not limited to, such things as 1) a bottle with a cap, 2) a jar with a lid, 3) a box with a flap, 4) a shipping container with a door, 5) a room with a door, 6) a building with a door, 7) a land area with a gate, 8) etc.

The security device may be attached to the container after the opening is closed, so that the next time the container is opened, the security device will break and the electrical continuity previously described will be broken. In some embodiments the security device 220 may comprise, for example, an RFID tag 210 attached to a base that is adhesively attached to doors 250, 260, such that when one or both doors is opened the security device will break along perforations 225, thus breaking continuity loop 230 at the same time. An RFID tag on a paper adhesive label may serve as one such example.

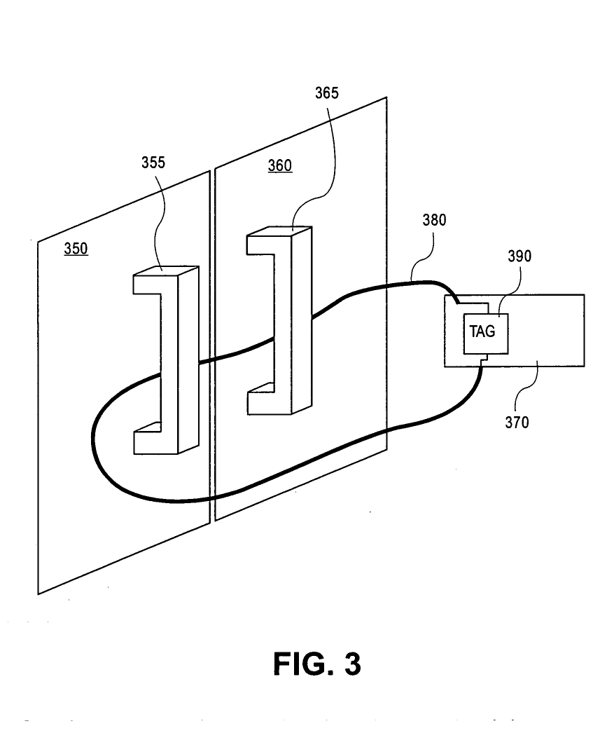

FIG. 3 shows a diagram of a security sensor with a continuity loop, according to an embodiment of the invention. In the illustrated embodiment, the security sensor may include RFID tag 390 on support 370, with an electrically conductive loop 380 providing electrical continuity between two contacts of the RFID tag 390. Support 370 may provide mechanical support for RFID tag 390 and the ends of loop 380, as well as a visual indication to show that the security sensor is in place.

FIG. 3 shows loop 380 passing through the handles 355, 365 that are attached to doors 350, 360, such that opening the doors will break the conductive loop 380, and electrically disconnect the two contacts of RFID tag 390 from each other. The conductive loop 380 may have a one-time connection mechanism (not shown) that permits the loop to be passed through the handles and then connected in a manner that is irreversible (e.g., once properly connected, the loop cannot be disconnected without breaking the loop in a manner that cannot be easily repaired in the field. The connection mechanism may be located in any feasible place between the two contacts of RFID tag 390, including on the support 370.

In some embodiments, at least a part of loop 380 may take the form of an insulated wire, with an electrically conductive inner core covered by a non-conductive surface to prevent the core from making electrical contact with metal doors. Other embodiments make take any other feasible forms. Electrically conductive loop 380 may include conductive paths on or in support 370, and the point at which the conductive loop 380 is likely to break may likewise be anywhere along the conductive loop 380, including portions of support 370. Although the illustrated embodiment shows loop 380 passing through two door handles, other configurations are also possible, provided the mechanical arrangement is such that once the loop is in place, opening the container will cause the electrical continuity provided by the loop to break.

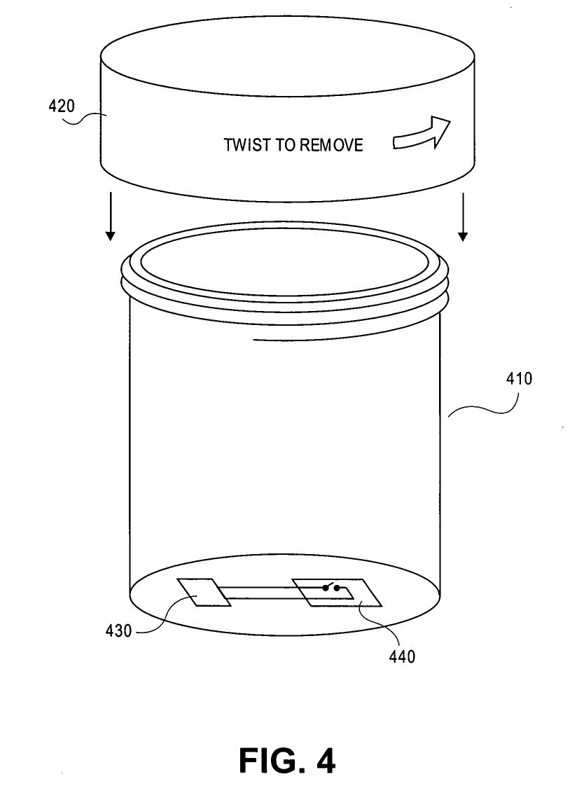

FIG. 4 shows a container with an RFID tag and an environmental change indicator, according to an embodiment of the invention. The illustrated embodiment shows a bottle (or jar or other container) 410 with a cap 420 that can be used to seal the contents within the bottle. In some embodiments, the lid may provide a pressure seal when the lid is firmly secured, so that if the lid is initially closed with the interior of the bottle under high pressure, evidence of a change of that pressure (such as to normal atmospheric pressure) would indicate that the bottle has since been opened. The illustrated embodiment shows an RFID tag 430 electrically connected to a pressure sensor 440. In one embodiment, the pressure sensor 440 may close its internal electrical switch when the pressure sensor is subjected to high ambient air pressure, and open the switch when the pressure sensor is subjected to normal air pressure. When the RFID tag is polled by an RFID reader, as described elsewhere in this document, the response from the RFID tag may indicate the state of the pressure in the bottle, and thereby indicate whether the bottle has been opened. In other embodiments, a bottle may be sealed under low pressure, and the sensor may indicate whether the pressure in the bottle is still low, or is normal indicating the bottle has possibly been opened.

Although FIG. 4 and the associated text describe a pressure sensor, other types of sensors may be used to indicate other environmental factors, such as but not limited to: 1) temperature (e.g., a melted fuse to indicate the contents were subjected to high heat, 2) radiation (e.g., a radiation dosimeter to indicate exposure to radiation), 3) a biological sensor (e.g., a biohazard detector to detect leakage of biological specimens from a smaller sealed container within the larger sealed container, 4) etc.

Although many of the examples described use a change in electrical continuity to indicate a detectable change of conditions, other techniques may also be used. For example, a sensor might produce a change of electrical resistance, which could then be measured directly and converted into a digital reading. The reading, or an indicator of the reading, could then be transmitted along with the tag's identification number. In a similar manner, the digital reading might be compared to a reference value, and the comparison then used as an indicator of a change of conditions.

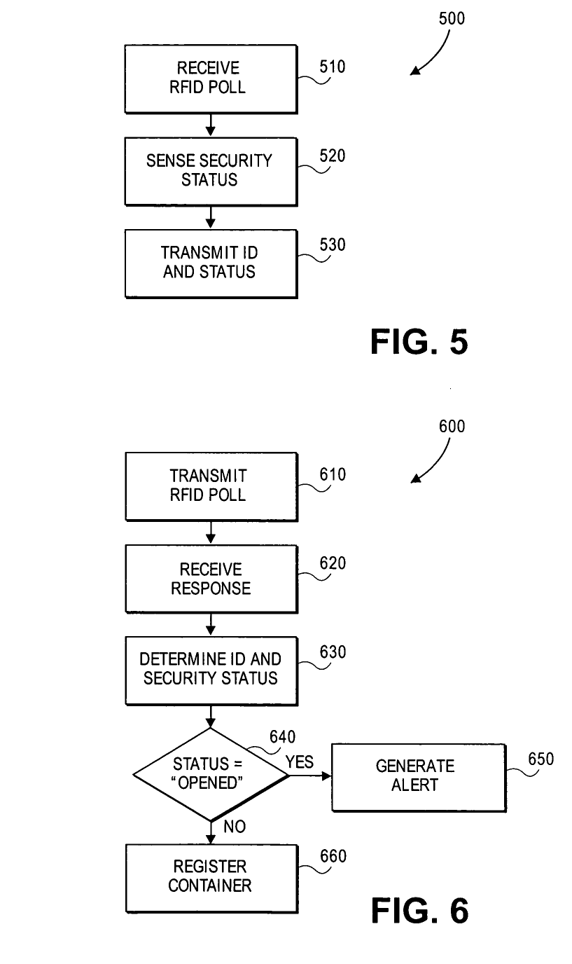

FIG. 5 shows a flow diagram of a method performed by an RFID tag, according to an embodiment of the invention. In flow diagram 500, at 510 a poll may be received by the RFID tag. When sufficient energy is received to power the circuitry in the RFID tag, at 520 the status of the security sensor may be determined (e.g., is there electrical continuity through the sensor?), and at 530 the RFID tag may transmit digital data comprising the RFID tag's identification code and the status of the security sensor.

FIG. 6 shows a flow diagram of a method performed by an RFID reader, according to an embodiment of the invention. In flow diagram 600, at 610 the RFID reader may transmit a poll. In some embodiments the poll may be a general purpose signal intended to trigger a response from any RFID tag within range that is able to receive the signal and respond to it. In other embodiments the poll may be intended for one or more specific RFID tags (e.g., by transmitting a destination address in the poll). In any case, a response from an RFID tag may be received at 620. At 630, the response may be processed by determining the identification code included in the response and by determining the security status that may be included in the response.

If the received status indicates a first state, the container to which the responding RFID tag is attached may be assumed to have not been tampered with, and normal processing may continue. Such normal processing may include registering the presence of the container at 660. For example, registering may include noting that the container has been received at a dock, and a presumption may be made that the original contents of the container are still intact. On the other hand, if the received status indicates a second state, the container may be assumed to have been possibly opened, and an alert may be generated at 650 to prompt further inspection of the container. The alert may take any feasible form, such as but not limited to any one or more of the following: 1) a visual warning indicator on an operator's video display, 2) an audible sound, 3) a message transmitted through wired or wireless means, 4) generation of control signals to secure the area, 5) etc.

The foregoing description is intended to be illustrative and not limiting. Variations will occur to those of skill in the art. Those variations are intended to be included in the various embodiments of the invention, which are limited only by the spirit and scope of the appended claims.

What is claimed is:

1. An apparatus, comprising:
a radio frequency identification (RFID) tag circuit;
an electrical element electrically coupled to the RFID tag circuit and mechanically disposed such that occurrence of a particular physical event will change the electrical coupling to the RFID tag circuit;
wherein the apparatus is adapted to transmit a first signal if the electrical coupling is unchanged and to transmit a second signal, different than the first signal, if the electrical coupling is changed.

2. The apparatus of claim 1, wherein the electrical element is adapted such that occurrence of the particular physical event will change electrical continuity between the electrical element and the RFID tag circuit in a manner detectable by the RFID tag circuit.

3. The apparatus of claim 2, wherein the change of electrical continuity is essentially irreversible.

4. The apparatus of claim 2, wherein the electrical element is adapted to cause an electrical discontinuity with the RFID tag circuit upon occurrence of the particular physical event.

5. The apparatus of claim 1, further comprising a device including the electrical element, wherein the device is attachable to an object in a manner such that the electrical element will change continuity responsive to the object being opened.

6. The apparatus of claim 5, wherein the electrical element is an antenna.

7. The apparatus of claim 5, wherein:
the object is a container with a movable part that may act to open and close the container; and
the device is adapted to be physically coupled to the movable part such that the change in continuity is responsive to opening the container.

8. The apparatus of claim 7, wherein the device is adhesively attachable to the movable part such that the electrical element will be physically broken responsive to opening the container.

9. The apparatus of claim 7, wherein the device is an electrically conductive loop adapted to be placed through an opening in the movable part and to be physically broken responsive to opening the container.

10. The apparatus of claim 1, wherein the electrical element is adapted to indicate an environmental change within the container.

11. The apparatus of claim 1, wherein the first and second signals each comprise at least one status bit appended to an identification code for the RFID tag, the at least one status bit to have a different state in the second signal than in the first signal.

12. A system, comprising:
a container including a movable part that may operate to open the container;
a radio frequency identification (RFID) tag;
an electrical element electrically coupled to the RFID tag and mechanically disposed such that opening the container will change electrical continuity between the electrical element and the RFID tag;
wherein the RFID tag is adapted to respond to an RFID poll by transmitting a status of the electrical continuity.

13. The system of claim 12, wherein the status of electrical continuity showing the container has been opened is essentially irreversible by the electrical element.

14. The system of claim 12, wherein the electrical element is physically disposed on the container such that opening the container will mechanically break the electrical element.

15. A method, comprising:
receiving a radio frequency identification (RFID) poll by an RFID tag; and
responding to the RFID poll with a transmission of data;
wherein the data includes at least one bit to indicate whether a container has been opened.

16. The method of claim 15, further comprising:
detecting an electrical continuity status that is indicative of whether the container has been opened; and
placing the status into the at least one bit.

17. The method of claim 16, wherein said detecting comprises detecting the electrical continuity status of an electrical element physically attached to the container.

18. The method of claim 16, wherein said detecting comprises detecting the electrical continuity status of an electrical element which was disposed through an opening of the container.

19. The method of claim 16, wherein said detecting comprises detecting the container has been opened if the continuity of an electrical element has been physically broken.

20. A method, comprising:
transmitting a wireless poll;
receiving a response to the poll from a radio frequency identification (RFID) tag; and
examining the response to determine if a security sensor that was coupled to the RFID tag has detected a status change.

21. The method of claim 20, wherein said examining comprises:
determining an identification for the RFID tag; and
determining if the status change indicates a possible physical event near the RFID tag.

22. The method of claim 21, wherein said physical event comprises at least one of:
opening a container; and
detecting an environmental change within the container.
